(19) United States
(12) Patent Application Publication
(10) Pub. No.: US 2024/0320052 A1
(43) Pub. Date: Sep. 26, 2024

(54) SYSTEMS AND METHODS FOR CONFIGURING HARDWARE TO RUN AN UNDEVELOPED DEVICE APPLICATION

(71) Applicant: Engineer.ai Corp., Salt Lake City, UT (US)

(72) Inventors: Sachin Dev Duggal, Salt Lake City, UT (US); Utsav Preet, London (GB); Rohan Patel, London (GB); Sugandha Agrawal, Delhi (IN)

(73) Assignee: Engineer.ai Corp., Salt Lake City, UT (US)

(21) Appl. No.: 18/188,457

(22) Filed: Mar. 23, 2023

(51) Int. Cl. G06F 9/50

(52) U.S. Cl. CPC G06F 9/5044

(57) ABSTRACT

Systems, methods, and, computer readable storage mediums for configuring a hardware needed for a developer to run an undeveloped device application are disclosed. The method includes providing a developer with a multitude of features, the features selectable, by the developer, for the undeveloped device application and receiving a selection of features from the multitude of features. The method further includes generating a machine-readable specification, capable of implementing the selection of features, for the undeveloped device application and generating a hardware configuration for the developer where the hardware configuration is capable of performing the selection of features of the machine-readable specification.

### FIELD OF THE INVENTION

This disclosure relates to software automation, machine learning AI, and project management.

### BACKGROUND

There is a high cost to running a business in the cloud. For instance, various cloud providers offer different hardware resources, but they may be priced differently and there is no easy way to determine the provider that delivers the best experience and for the best price. Similarly, it is difficult to determine the hardware or platform on a single provider that provides the best experience. Instead, developers may be forced to experiment with various hardware configurations and with various cloud providers to discover an ideal setup.

Once a developer selects a cloud provider, the developer may be hard-pressed to streamline the provisioning of cloud resources from the cloud provider. Multiple types of storage and memory are available. Multiple nodes and CPUs may be available. The prospect of optimizing all such resources may be daunting and time-consuming for any developer.

There is a need in the art or technology that addresses the above-stated issues and simplifies the process of developing a device application with a cloud provider.

### SUMMARY

Systems, methods, and computer readable storage mediums are disclosed for predicting hardware and resources to run a device application. An exemplary embodiment is a method for predicting hardware capable of running a device application. The method includes receiving a selection of features where the selection includes one or more features to run on the device application. The method includes determining one or more components that are capable of performing the selection of features when the one or more components are built into the device application. The method further includes determining one or more linkages between the one or more components and generating a machine-readable specification to build the device application where the machine-readable specification includes the one or more components and the one or more linkages. The method further includes determining a hardware that is capable of running the device application where the device application includes the machine-readable specification. The method may further include determining one or more providers that offer the hardware. The method may further include generating a package for each of the one or more providers where each package includes the hardware. The method may further include generating a hardware configuration for each package where the hardware configuration is capable of performing the machine-readable specification. The method may further include generating a resource cost for each package based on the hardware configuration. Determining the hardware may include analyzing historical data for the selection of features. Analyzing historical data may include mapping one or more features of the selection of features to a closest core feature that is in a catalog of features.

Another general aspect is a computer system to predict a hardware capable of running a device application. The computer system includes a processor coupled to a memory where the processor is configured to receive a selection of features, the selection includes one or more features to run on the device application. The processor is further configured to determine one or more components that are capable of performing the selection of features when the one or more components are built into the device application. The processor is further configured to determine one or more linkages between the one or more components. The processor is further configured to generate a machine-readable specification to build the device application where the machine-readable specification includes the one or more components and the one or more linkages. The processor is further configure to determine a hardware that is capable of running the device application where the device application includes the machine-readable specification. The processor may be further configured to determine one or more providers that offer the hardware. The processor may be further configured to generate a package for each of the one or more providers where each package includes the hardware. The processor may be further configured to generate a hardware configuration for each package where the hardware configuration is capable of performing the machine-readable specification. The hardware may be further configured to generate a resource cost for each package based on the hardware configuration. Determining the hardware may include the processor being further configured to analyze historical data for the selection of features. Analyzing historical data may include the processor being further configured to map one or more features of the selection of features to a closest core feature that is in a catalog of features.

An exemplary embodiment is a computer readable storage medium having data stored therein representing software executable by a computer where the software includes instructions. When executed, the instructions cause the computer readable storage medium to perform receiving a selection of features, the selection comprising one or more features to run on a device application. The instructions cause the computer readable storage medium to further perform determining one or more components that are capable of performing the selection of features when the one or more components are built into the device application. The instructions further cause the computer readable storage medium to perform determining one or more linkages between the one or more components and generating a machine-readable specification to build the device application where the machine-readable specification includes the one or more components and the one or more linkages. The instructions further cause the computer readable storage medium to perform determining a hardware that is capable of running the device application where the device application includes the machine-readable specification. The instructions may further cause the computer readable storage medium to perform determining one or more providers that offer the hardware. The instructions may cause the computer readable storage medium to perform generating a package for each of the one or more providers where each package includes the hardware. The instructions may cause the computer readable storage medium to perform generating a hardware configuration for each package where the hardware configuration capable of performing the machine-readable specification. The instructions may cause the computer readable storage medium to perform generating a resource cost for each package based on the hardware configuration. Determining the hardware may include analyzing historical data for the selection of features where analyzing historical data includes mapping one or more features of the selection of features to a closest core feature that is in a catalog of features.

Another general aspect is a method for determining a hardware system to run an undeveloped device application. The method includes determining one or more hardware components that are capable of performing a selection of features for an undeveloped device application and determining one or more providers that offer the one or more hardware components. The method further includes generating a package for each of the one or more providers, the package including the one or more hardware components, and generating a provider configuration capable of running the undeveloped device application on the one or more hardware components. Determining one or more hardware components may be responsive to a selection of features for the undeveloped device application. Determining the one or more hardware components may be further responsive to a selection of an amount of concurrent users for the undeveloped device application. Determining the one or more hardware components may include using a machine learned prediction algorithm that is trained on historical data. The method may further include determining a resource cost for the hardware configuration. The method may further include generating a machine-readable specification comprising one or more components for the device application. Generating each package may include optimizing each package based on a resource cost of the package.

An exemplary embodiment is a computer system to predict a hardware capable of running a device application. The computer system includes a processor coupled to a memory. The processor is configured to determine one or more hardware components capable of performing a selection of features for an undeveloped device application and determining one or more providers that offer the one or more hardware components. The processor is further configured to generate a package for each of the one or more providers, the package including the one or more hardware components, and generate a provider configuration capable of running the undeveloped device application on the one or more hardware components. Determining the one or more hardware components may be responsive to a selection of features for the undeveloped device application. Determining the one or more hardware components may include the processor being further configured to use a machine learned prediction algorithm that is trained on historical data. The processor may be further configured to determine a resource cost for the hardware configuration. The processor may be further configured to generate a machine-readable specification including one or more components for the device application. Generating each package may include the processor being further configured to optimize each package based on a resource cost of the package.

Another general aspect is a computer readable storage medium having data stored therein representing software executable by a computer. The software includes instructions that, when executed, cause the computer readable storage medium to perform determining one or more hardware components capable of performing a selection of features for an undeveloped device application. The instructions further cause the computer readable storage medium to perform determining one or more providers that offer the one or more hardware components and further perform generating a package for each of the one or more providers where the package includes the one or more hardware components. The instructions may further cause the computer readable storage medium to perform generating a provider configuration capable of running the undeveloped device application on the one or more hardware components. Determining one or more hardware components may be responsive to a selection of features for the undeveloped device application. Determining the one or more hardware components may be further responsive to a selection of an amount of concurrent users for the undeveloped device application. Determining the one or more hardware components may include using a machine learned prediction algorithm that is trained on historical data. The instructions may further cause the computer readable storage medium to perform determining a resource cost for the hardware configuration. The instructions may further cause the computer readable storage medium to perform generating a machine-readable specification comprising one or more components for the device application.

An exemplary embodiment is a method for configuring a hardware needed for a developer to run an undeveloped device application. The method includes providing a developer with a multitude of features, the features selectable, by the developer, for the undeveloped device application and receiving a selection of features from the multitude of features. The method further includes generating a machine-readable specification, capable of implementing the selection of features, for the undeveloped device application and generating a hardware configuration for the developer where the hardware configuration is capable of performing the selection of features of the machine-readable specification. Generating the hardware configuration may include minimizing a resource cost of the hardware configuration for the developer. The method may further include applying the hardware configuration to one or more hardware providers and determining a resource cost for the hardware configuration on each of the one or more providers. The method may further include opening an account for the developer with at least one of the one or more providers. Generating the hardware configuration may include using a machine learned algorithm that is trained on historical data of core features and corresponding hardware configurations. Generating the hardware configuration may further include mapping one or more features of the selection of features to one or more closest core features. The method may further include receiving, from the developer, a selection of concurrent users for the undeveloped device application where generating the hardware configuration is based on the selection of concurrent users.

Another general aspect is a computer system to predict a hardware capable of running an undeveloped device application. The computer system includes a processor coupled to a memory. The processor is configured to provide a developer with a multitude of features, the features selectable, by the developer, for the undeveloped device application and receive a selection of features from the multitude of features. The processor is further configured to generate a machine-readable specification, capable of implementing the selection of features, for the undeveloped device application and generate a hardware configuration for the developer where the hardware configuration is capable of performing the selection of features of the machine-readable specification. Generating the hardware configuration may include the processor being further configured to minimize a resource cost of the hardware configuration for the developer. The processor may be further configured to apply the hardware configuration to one or more hardware providers and determine a resource cost for the hardware configuration on each of the one or more providers. The processor may be further configured to open an account for the developer with at least one of the one or more providers. Generating the hardware configuration may include the processor being configured to use a machine learned algorithm that is trained on historical data of core features and corresponding hardware configurations. Generating the hardware configuration may include the processor being configured to map one or more features of the selection of features to one or more closest core features. The processor may be further configured to receive, from the developer, a selection of concurrent users for the undeveloped device application where generating the hardware configuration is based on the selection of concurrent users.

An exemplary embodiment is a computer readable storage medium having data stored therein representing software executable by a computer. The software includes instructions that, when executed, cause the computer readable storage medium to perform providing a developer with a multitude of features, the features selectable, by the developer, for an undeveloped device application. The instructions further cause the computer readable storage medium to perform receiving a selection of features from the multitude of features and generating a machine-readable specification, capable of implementing the selection of features, for the undeveloped device application. The instructions further cause the computer readable storage medium to perform generating a hardware configuration for the developer, the hardware configuration capable of performing the selection of features of the machine-readable specification. Generating the hardware configuration may include minimizing a resource cost of the hardware configuration for the developer. The instructions may further cause the computer readable storage medium to perform applying the hardware configuration to one or more hardware providers and determining a resource cost for the hardware configuration on each of the one or more providers. The instructions may further cause the computer readable storage medium to perform opening an account for the developer with at least one of the one or more providers. Generating the hardware configuration may include using a machine learned algorithm that is trained on historical data of core features and corresponding hardware configurations. Generating the hardware configuration may further include mapping one or more features of the selection of features to one or more closest core features.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic of an embodiment of a system for predicting a hardware configuration in the disclosed subject matter.

FIG. 6 is a flow diagram of an embodiment of a process for predicting a hardware configuration in the disclosed subject matter.

FIG. 7 is another flow diagram of an embodiment of a process for predicting a hardware configuration in the disclosed subject matter.

FIG. 8 is yet another flow diagram of an embodiment of a process for predicting a hardware configuration in the disclosed subject matter.

FIG. 9 is an illustration of a hardware configuration list in an embodiment of the disclosed subject matter.

FIG. 10 is a screenshot of an embodiment of a user interface that displays an output of the hardware configuration dependent on a concurrent number of users.

FIG. 11 is a screenshot of an embodiment of a user interface that displays a multitude of templates for a hardware configuration.

FIG. 12 is a schematic illustrating the computing components that may be used to implement various features of embodiments described in the disclosed subject matter.

### DETAILED DESCRIPTION

The disclosed subject matter is a method, system, and computer readable storage medium for allocating cloud resources to run a device application. A developer may use the disclosed subject matter to quickly allocate hardware that is provided by one or more providers to run the device application. The allocated hardware may be capable of implementing all features of a device application. Accordingly, the developer may save time and expense in setting up a cloud-based platform to run a device application.

In an exemplary embodiment, a developer may select a multitude of features for a device application. Responsive to the selection of features, a computer system determines hardware requirements to implement the multitude of features. In various embodiments, the computer system implements a machine learning algorithm in the determination. For example, the computer system may determine hardware based on training data for the same core features. In an exemplary embodiment where training data does not exist for one or more features selected by the developer, the system may determine one or more core features that are close to the selected features for which training data does not exist.

In various embodiments, the disclosed computing system may determine one or more cloud providers that provide all or a portion of the determined hardware. For example, a cloud provider may host a multitude of servers that can run one or more device applications. Examples of cloud providers include, but are not limited to, AWS services, Microsoft Azure, and Google cloud services. The computing system may determine one or more hardware configurations for each cloud provider. In various embodiments, the hardware configuration comprises one or more cloud services. The hardware configuration may further comprise a developer account that is set up to run the one or more services on the cloud provider.

The disclosed computing system may further determine a resource cost of the various cloud services for each cloud provider. As used herein, a resource may refer to any asset that may be applied to a cloud provider. Examples of resources may include but are not limited to computing power, memory, nodes, computing time, number of cloud services, storage, CPUs, the associated cost thereof, and the like. The disclosed computing system may optimize a cloud provider hardware configuration based on any computing resource. Accordingly, a developer may save time and the expense of determining an ideal cloud provider and an ideal hardware configuration for the cloud provider.

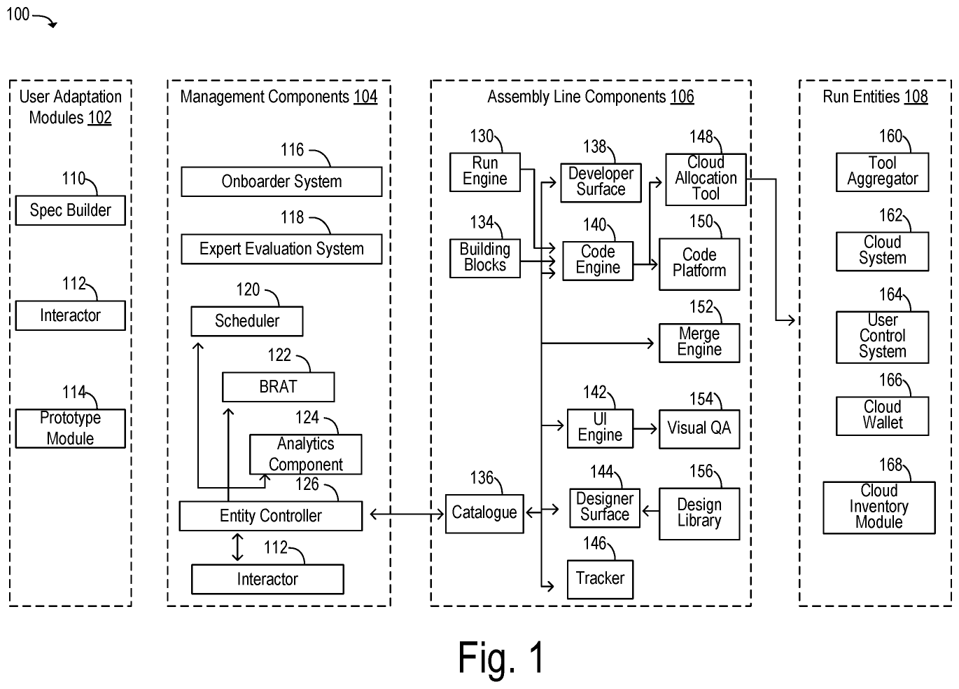

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation. user adaptation modules 102 may intelligently link a user to various entities of the software building system 100 based on the specific needs of the user.

The user adaptation modules 102 may include specification builder 110, an interactor 112 system, and the prototype module 114. They may be used to guide a user through a process of building software and managing a software project. Specification builder 110, the interactor 112 system, and the prototype module 114 may be used concurrently and/or link to one another. For instance, specification builder 110 may accept user specifications that are generated in an interactor 112 system. The prototype module 114 may utilize computer generated specifications that are produced in specification builder 110 to create a prototype for various features. Further, the interactor 112 system may aid a user in implementing all features in specification builder 110 and the prototype module 114.

Spec builder 110 converts user supplied specifications into specifications that can be automatically read and implemented by various objects, instances, or entities of the software building system 100. The machine readable specifications may be referred to herein as a buildcard. In an example of use, specification builder 110 may accept a set of features, platforms, etc., as input and generate a machine readable specification for that project. Specification builder 110 may further use one or more machine learning algorithms to determine a cost and/or timeline for a given set of features. In an example of use, specification builder 110 may determine potential conflict points and factors that will significantly affect cost and timeliness of a project based on training data. For example, historical data may show that a combination of various building block components create a data transfer bottleneck. Specification builder 110 may be configured to flag such issues.

The interactor 112 system is an AI powered speech and conversational analysis system. It converses with a user with a goal of aiding the user. In one example, the interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, the NLP implemented by interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

The prototype module 114 may use a secondary machine learning algorithm to select a most likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a best fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with valuable critique and provide the onboarding system 116 with metrics with it can use to allocate the experts on future tasks.

Scheduler 120 keeps track of overall progress of a project and provides experts with job start and job completion estimates. In a complex project, some expert developers may be required to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation tool (BRAT 122) is capable of generating optimal developer assignments for every available parallel workstream across multiple projects. BRAT 122 system allows expert developers to be efficiently managed to minimize cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the best experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the Interactor 112 system may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specifications. The term buildcards, as used herein, refer to machine readable specifications that are generated by specification builder 110, which may convert user specifications into a computer readable specification that contains the user specifications and a format that can be implemented by an automated process with minimal intervention by expert developers.

The computer readable specifications are constructed with building block components 134, which are reusable code components. The building block components 134 may be pretested code components that are modular and safe to use. In an exemplary embodiment, every building block component 134 consists of two sections-core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components required by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 148 manages cloud computing that is associated with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

Visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 120 so they can be reviewed by expert developers.

In an exemplary embodiment, visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for easy submission of designs to the computer readable specification. Submitted designs may be immediately available for further customization by expert developers that are connected to a project network.

Similar to building block components 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over every feature of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user need only set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

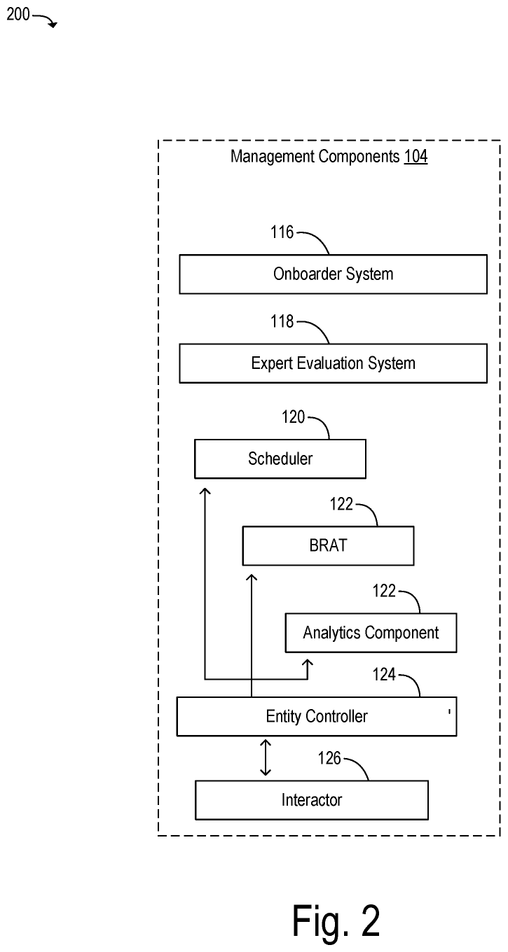

Referring to FIG. 2, FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into scheduler 120 to determine a timeline for jobs to be completed by developer experts and designers. The BRAT 122 system may be leveraged to score and rank experts for jobs in scheduler 120. A user may interact with the various entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

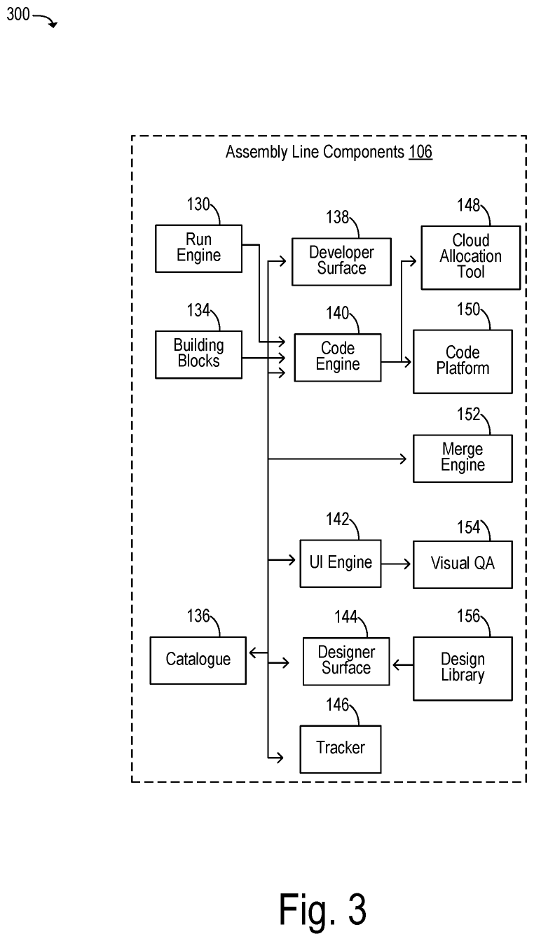

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building block components, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel to pixel comparison and logs any discrepancies to be evaluated by an expert developer.

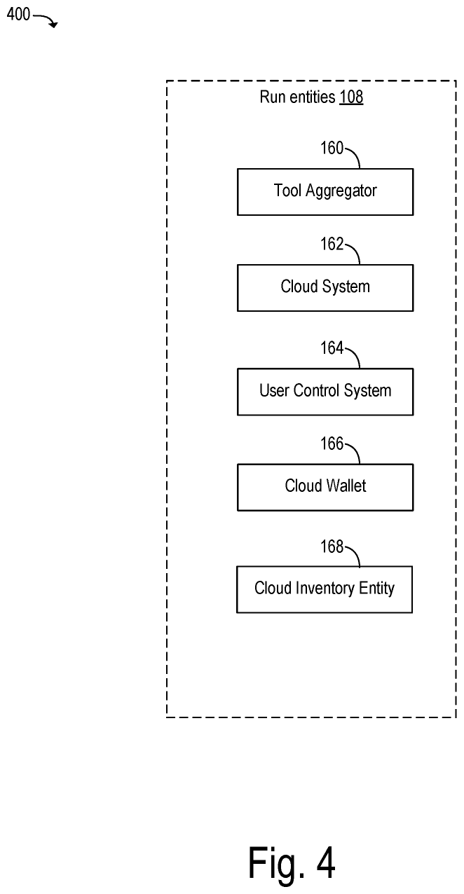

Referring to FIG. 4, FIG. 4 is a schematic 400 illustrating an embodiment of the run entities 108 of the software building system. The run entities 108 provides a user with 3^{rd} party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 160 automatically subscribes with appropriate 3^{rd} party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

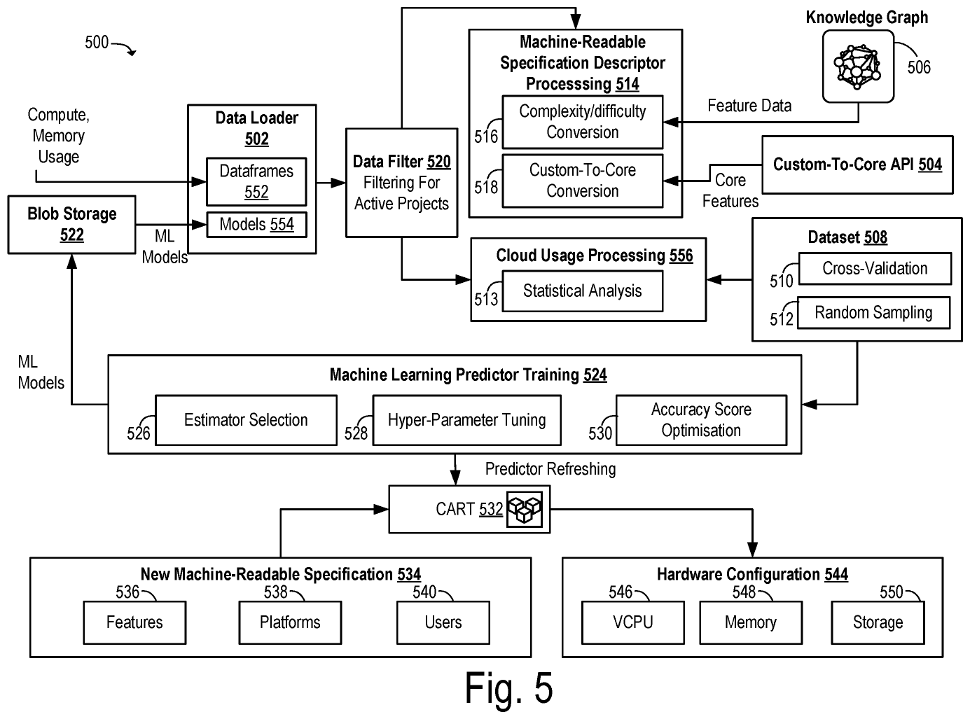

Referring to FIG. 5, FIG. 5 is a schematic 500 of an embodiment of a system for predicting a hardware configuration 544 in the disclosed subject matter. The system includes a cloud allocation recommendation tool (CART 532) that determines a hardware configuration 544 for a developer. In various embodiments, the hardware configuration 544 generated by CART 532 may include a recommendation for virtual CPUs (VCPUs 546), memory 548, and storage 550 in a cloud provider. In one implementation, the recommendation may be scalable based on the number of users for the device application. For example, the hardware configuration 544 may include a separate VCPU 546, memory 548, and storage 550 for various user numbers such as a hardware configuration for one to 500 users, a hardware configuration for 500 to 1500 users, and a hardware configuration for 1500 to 3000 users.

The developers input to the CART 532 may include a machine-readable specification 534 for device application, which is also referred to herein as a buildcard. The machine-readable specification 534, submitted by the developer, may include one or more features 536, one or more platforms 538 for the device application, and a number of concurrent users 540. Examples of features 536 for the device application may include a login feature, a forgot password feature, a geo-locator feature, a chat feature, a product browse feature, etc. In various embodiments, there is no limit to the number or type of features that may be selected by a developer to be included in a device application. Each of the platforms 538 may be a platform to which the device application runs. Examples of platform include, but are not limited to iphone, android, desktop, web browser, Xbox, Chromebox, and Apple watch.

The CART 532 may use a machine learning predictor model based on machine learning predictor training 524 to determine the hardware configuration 544 based on the machine-readable specification 534. The predictor model accepts the machine-readable specification 534 as input and outputs a hardware configuration 544. The predictor model is trained based on historical machine-readable specifications and their corresponding hardware configurations. In various embodiments, the machine learning predictor training 524 includes estimator selection 526, hyper-parameter tuning 528, and accuracy score optimization 530. Hyper-parameter tuning 528 is a process of selecting and optimizing values for a machine learning model.

Hyperparameters are the configuration settings of a model that are set before training, such as the learning rate, regularization strength, number of hidden layers in a neural network, and others. Hyper-parameter tuning 528 works with the accuracy score optimization 530 to improve hardware configurations that are determined based on machine-readable specifications 534. The estimator selector 526 selects a best machine learning model to use to determine the hardware configuration based on the machine-readable specification 534. Various machine learning models may be considered by the estimator selection. The various machine learning models include but are not limited to neural networks random forests and gradient-boosting machines. Various machine learning models may be used for the predictor model including but not limited to gradient boosting machines and neural networks.

In an exemplary embodiment, the computing system continually refines the predictor model by saving output from the machine learning protector training 524 to a blob storage 522. Blob storage 522 refers to the storage of unstructured data. Here the blob storage 522 may store data related to machine learning models that were refined by the machine learning predictor training 524. The blob storage may feed the machine learning model data to a data loader 502. The data loader 502 may include data frames 552 and machine learning models 554. The data frames 552 may include various parameters and configurations in a server or cloud environment. The models 554 may include data related to machine learning models that were output by the machine learning predictor training 524. The data loader 502 may feed data into the data filter 520 which may be configured to filter the data for active projects.

Filter data that is output by the data filter 520 may be transferred to the machine-readable specification descriptor processing 514, which generates recommendations based on features in the machine-readable specification. Recommendations generated by the machine-readable specification descriptor processing 514 may be used by the machine learning protector training 524 and various machine learning models. The machine-readable specification descriptor processing 514 may include a complexity/difficulty conversion 516 and a custom-to-core conversion 518. The complexity/difficulty conversion 516 may accept knowledge graph 506 data, which may include common connections between core features and hardware configurations which may be processed by the complexity/difficulty conversion 516 to output recommendations of hardware configurations. The custom-to-core conversion 518 determines core features that are most related to custom features that are not found in the knowledge graph. For example, a developer may draft one or more custom features that are new or are not included in the knowledge graph. The custom-to-core API 504 includes one or more functions that compare a custom feature to a core feature.

The dataset 508 may test predictor models that are output by the machine learning protector training 524. The dataset may include cross-validation 510 and random sampling 512. The cross-validation 510 may evaluate the performance of various predictor models on training datasets. The random sampling 512 may generate the various datasets to which the cross-validation 510 tests the predictor models. Output from the dataset 508 may be fed into the machine learning protector training 524. Output from the dataset 508 may also be transmitted to the cloud usage processing 556 which may perform a statistical analysis 513 on active projects. In various embodiments, the statistical analysis 513 may analyze computing system for various trends in hardware configuration 544 output such as increased or decreased resource costs for the VCPU 546, memory 548, and storage 550 predictions.

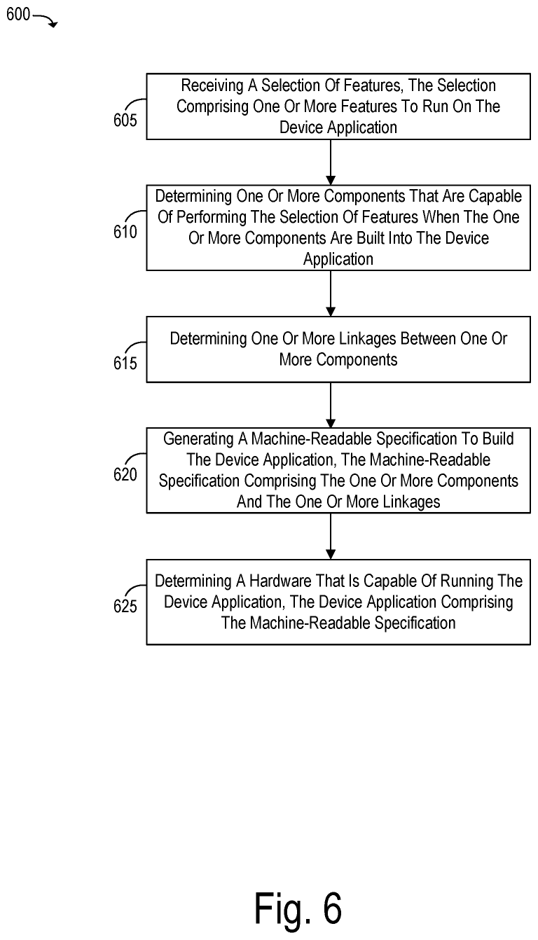

Referring to FIG. 6, FIG. 6 is a flow diagram 600 of an embodiment of a process for predicting a hardware configuration in the disclosed subject matter. The process may be used to determine a hardware configuration for a device application. The device application may comprise an application that runs on a hardware device such as a mobile phone, desktop computer, laptop computer, television, console device, automobile media player, an IOT device, or the like. In various embodiments, a developer may employ the process before, during, or after the development of the device application. In various embodiments, the process may be incorporated as part of a device application development process.

At step 605 of the process, the computing system may receive a selection of features, the selection comprising one or more features to run on the device application. A developer may select features for a device application before or after the device application is developed. A computing system may then receive the selection from the developer. In an example of use, a developer may select one or more features from a list of features on a web browser that is run by the disclosed computing system.

At step 610, the computing system may determine one or more components that are capable of performing the selection of features when the one or more components are built into the device application. The components may be building block components or similar functions, modules, or components that may be used to construct a device application. In various embodiments the computing system may use a machine learning algorithm to select the one or more components based on training data that includes various feature and building block component combinations.

At step 615, the computer system may determine one or more linkages between one or more components. The linkages may be connections or the like that allow the various components to communicate with one another. In an exemplary embodiment, the linkages are facilitated by a run engine that allows messages to be communicated between the components.

At step 620, the computing system may generate a machine-readable specification to build the device application. The machine-readable specification includes the one or more components and one or more linkages. The machine-readable specification may allow a computing system to verify that all or a portion of the features in the machine-readable specification are met. In various embodiments, the computer system may initiate development for a device application using the machine-readable specification. In an exemplary embodiment the computer system may automatically complete development of the device application using the machine-readable specification.

At step 625, the computing system may determine a hardware that is capable of running the device application where the device application includes the machine-readable specification. In various embodiments, the hardware is determined by the CART 532 tool. In various embodiments, the computing system determines the hardware to run on one or more cloud platforms. In an exemplary embodiment, the hardware may comprise one or more CPU clusters, an amount of memory, and one or more storage services. The computing system may further determine a resource cost for the hardware and optimize the resource cost for the various services. For instance, the computing system may select one or more storage services to optimize resources for the developer. In various embodiments, the computing system may determine multiple hardware configurations for the developer. For example, the computing system may determine a hardware configuration for a minimum number of concurrent users, a moderate amount of concurrent users, and a large amount of concurrent users. In another example, the computing system may determine a hardware configuration for a first cloud provider and a second provider.

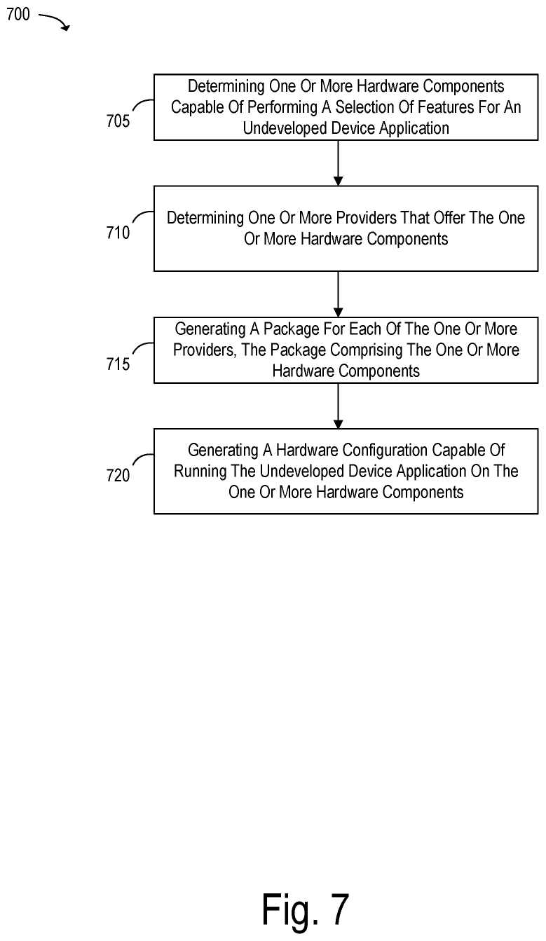

Referring to FIG. 7, FIG. 7 is another flow diagram 700 of an embodiment of a process for predicting a hardware configuration in the disclosed subject matter. In step 705 of the process, the computer system may determine one or more hardware components capable of performing a selection of features for an undeveloped device application. The term undeveloped device application, as used herein, refers to an application that is not yet started development or has incomplete development. In various embodiments, the one or more hardware components are determined by a CART 532 tool. The selection of features may be a list of any features for the device application. A feature for device application may be any functionality of the device application. For example, a shopping device application may include a login feature, a browsing feature, a product selecting feature, a shopping cart feature, and a purchasing feature. The selection of features may be communicated to the computer system in any way. In an exemplary embodiment, a developer may select a multitude of features on a webpage hosted by the computing system.

At step 710, the computing system may determine one or more providers to offer the one or more hardware components. The term provider, as used herein refers to any service that provides hardware resources. In various embodiments, the developer may set one or more parameters for the determination of the one or more providers. For example, a developer may wish to limit the determination to a set of providers determined by the developer. In another example, the developer may request that only providers that meet certain requirements be considered. For example, the developer may request that only providers that offer serverless compute functions be considered.

At step 715, the computing system may generate a package for each of the one or more providers where the package includes the one or more hardware components. The term package, as used herein, refers to a list of products or services that are offered by the provider. Accordingly, the developer may gain access to the hardware by purchasing the generated package. In exemplary embodiments, the computing system may further open an account for the developer to generate the package.

At step 720, the computing system may generate a provider configuration capable of running the undeveloped device application on the one or more hardware components. The term provider configuration, as used herein, refers to any document, commands, executable, list, functions, software, or the like, that may be processed by the provider to run the device application on the one or more hardware components that are operated by the provider. For example, the computing system may generate a provider configuration that causes one or more processors, one or more storage services, and memory to run a device application.

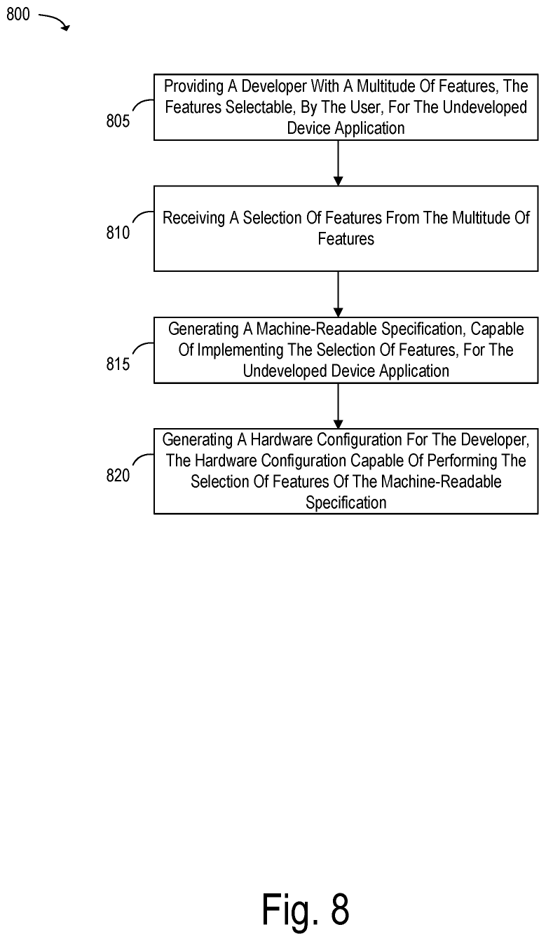

Referring to FIG. 8, FIG. 8 is yet another flow diagram 800 of an embodiment of a process for predicting a hardware configuration in the disclosed subject matter. The process may be used to develop a device application and run the device application on the hardware that is provided by a cloud provider. At step 805 of the process, the computing system may provide a developer with a multitude of features. The features are selectable by the developer for an undeveloped device application. In an exemplary embodiment, the developer may access a list of selectable features through a web browser that is run by the computing system of the disclosed subject matter. The developer may select one or more of the features that the developer wants to develop into a device application. Once the features are selected, at step 810, the computing system may receive the selection of features from the multitude of features. In the exemplary embodiment above, the computing system may receive the developer selections in the web browser.

At step 815, the computing system may generate a machine-readable specification for the undeveloped device application that is capable of implementing the selection of features. In various embodiments, the computing system may determine one or more components and one or more linkages between the components to generate the machine-readable specification. The machine-readable specification may include all information necessary for a computing system to automatically generate the device application. In various embodiments, the machine readable specification may be used to verify that a device application includes all of the selected features.

At step 820, the computing system may generate a hardware configuration for the developer. The hardware configuration may be capable of performing the selection of features of the machine-readable specification. The computing system may determine the hardware configuration based on one or more parameters that are set by the developer. For instance, the developer may specify one or more resources to minimize such as the amount of RAM to allocate or the number of CPU nodes. In various embodiments, the hardware configuration may be generated to minimize the monetary cost to the developer to implement the hardware configuration with a cloud provider. The computing system may generate a hardware configuration for one or more cloud providers. The hardware configuration may change based on the cloud provider and the services provided by the cloud provider. Likewise the optimization may change based on the cloud provider as the cloud provider may provide different products and services and at different monetary costs.

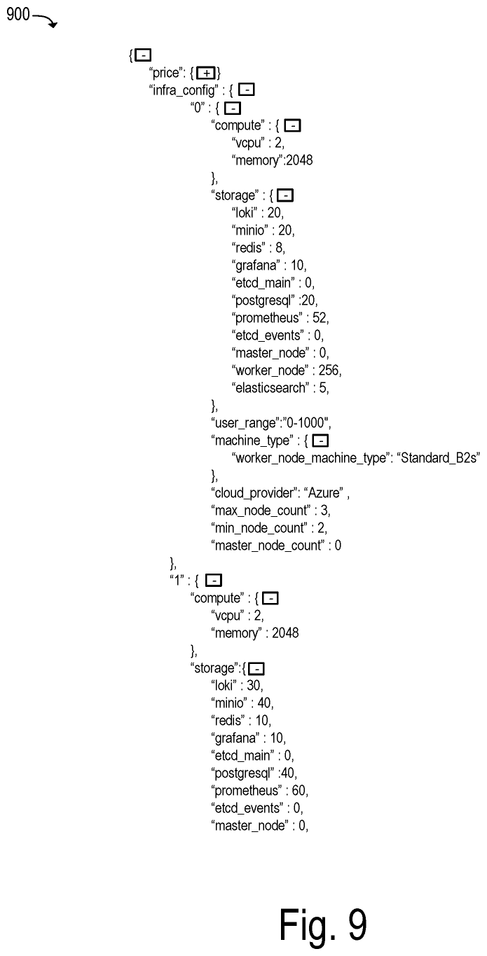

Referring to FIG. 9, FIG. 9 is an illustration 900 of a hardware configuration list in an embodiment of the disclosed subject matter. The hardware configuration may include a list of one or more services provided by a cloud provider. Although the hardware configuration in FIG. 9 is provided in a JavaScript object notation (JSON) format, the hardware configuration may be provided in any format that may communicate a hardware configuration to a cloud provider.

The hardware configuration includes a price object and an infra_config object. The infra_config object includes multiple service/product specifications based on a number of users. The first service/product specification is listed by the “0” object, which lists two VCPU cores and 2048 MB of memory. The “0” object includes a list of storage databases with an amount of storage in gigabytes.

For example, the hardware configuration includes 20 GB for the Loki log aggregation tools, 20 GB for Minio cloud storage, 8 GB for a Redis database, 10 GB for Grafana analytics, 20 GB for a Postgresql database, 52 GB for a Prometheus monitoring system, 256 worker nodes for a Kubernetes system, and 5 GB for an Elasticsearch database.

The maximum node account for the “0” object is three nodes and the minimum note count is two nodes. The number of concurrent users for the “0” object is between 0 and 1000. The price object, which is minimized, may display a monetary cost for each object. In the embodiment shown in FIG. 9, the “1” object, which is partially shown in the illustration 900, lists a similar hardware configuration for a greater number of concurrent users.

The hardware configuration shown in FIG. 9 may be configured to be accepted by one or more cloud providers. In various embodiments, the computer system may automatically open an account with a cloud provider that includes all hardware components listed in the hardware configuration.

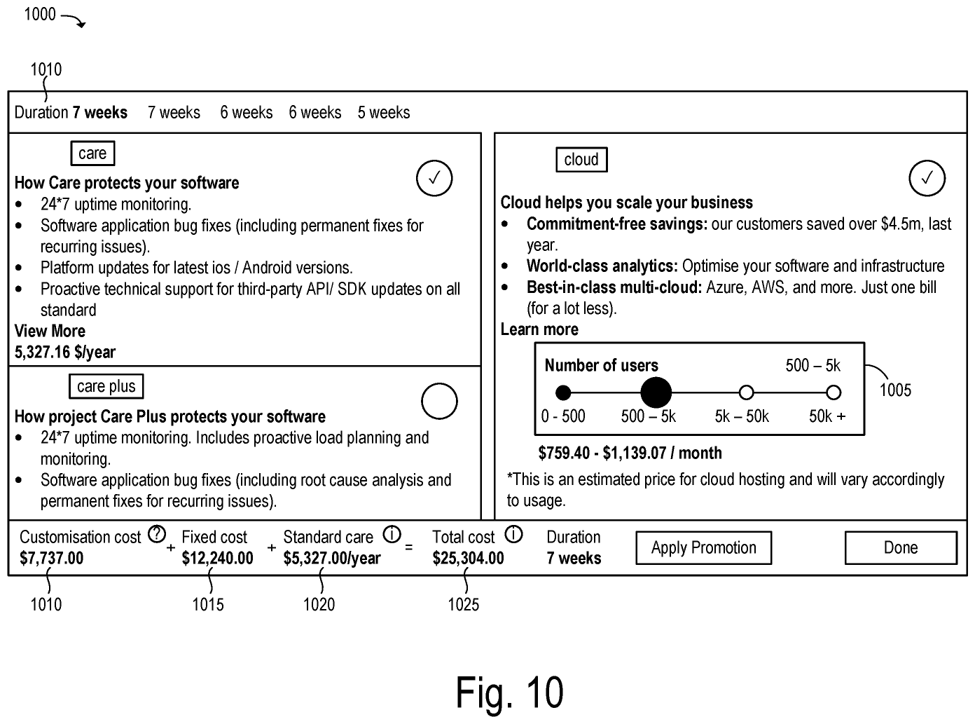

Referring to FIG. 10, FIG. 10 is a screenshot 1000 of an embodiment of a user interface that displays an output of the hardware configuration dependent on a concurrent number of users. The user interface may allow a developer to quickly generate a hardware configuration based on one or more parameters. For example, a developer may select a number of concurrent users to provide a device application through a cloud provider. The computer system may then predict a cost to run the device application on the cloud provider for the developer.

In the exemplary embodiment shown in FIG. 10, the developer may also set a development duration 1005 for features that the developer selected. The features are not shown. Based on the selected features and the number of concurrent users, the computing system may determine a cost to develop and maintain a device application through a cloud provider.

As shown in the screenshot 1000, a total cost 1025 includes a customization cost 1010 for developing custom features, a fixed cost 1015 for developing the device application, and a standard care cost 1020 for maintaining device application through the cloud provider. A developer may easily modify one or more parameters to see a change in the cost. Other resources such as CPU, memory, and storage may be similarly visualized.

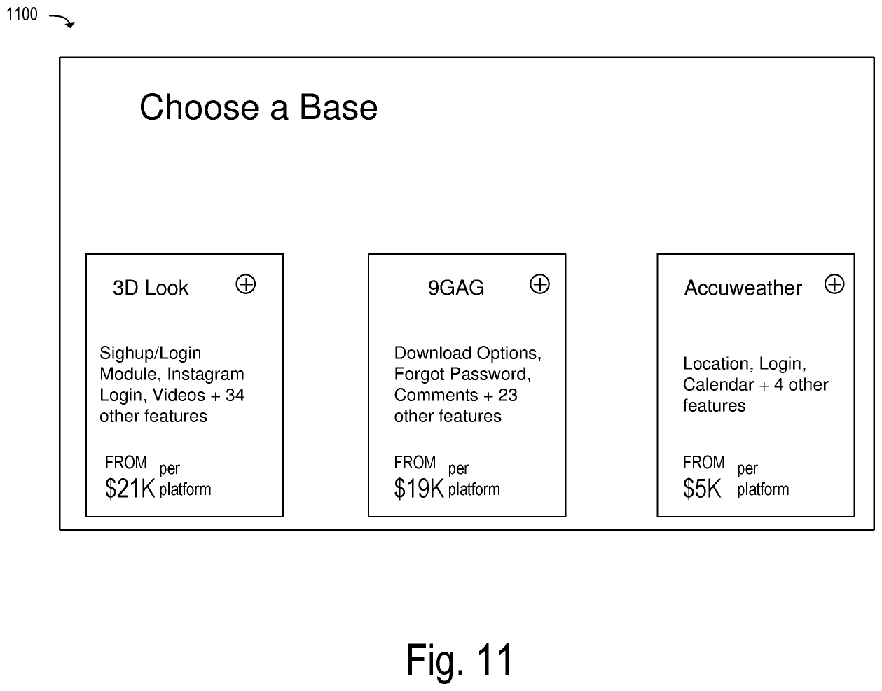

Referring to FIG. 11, FIG. 11 is a screenshot 1100 of an embodiment of a user interface that displays a multitude of templates for a hardware configuration. The computing system may provide a developer with one or more selectable templates for a device application. Once selected, the developer may customize the template to develop the device application. Each template may include a selection of features and a corresponding hardware configuration to run the features through a cloud provider.

As shown in the screenshot 1100, the developer is offered a selection of at least three separate templates to begin the development of the device application. Further, the developer may scroll to view more templates. Once the developer selects a template, the computing system may list the features of the template, which allows the developer to customize the device application by adding or removing one or more features from the template.

Each template may be streamlined such that an optimal hardware configuration is available for the features in the template. When the developer adds custom features to the template, the computing system may use the CART 532 tool to update the hardware configuration accordingly. In various embodiments, the computing system may automatically generate a device application, open an account with a cloud provider, and run the device application through the cloud provider using the optimized hardware configuration. Thus, a developer may implement a device application based on a short interaction with the computing system through a web browser by selecting a template, selecting features, and selecting one or more parameters for a hardware configuration.

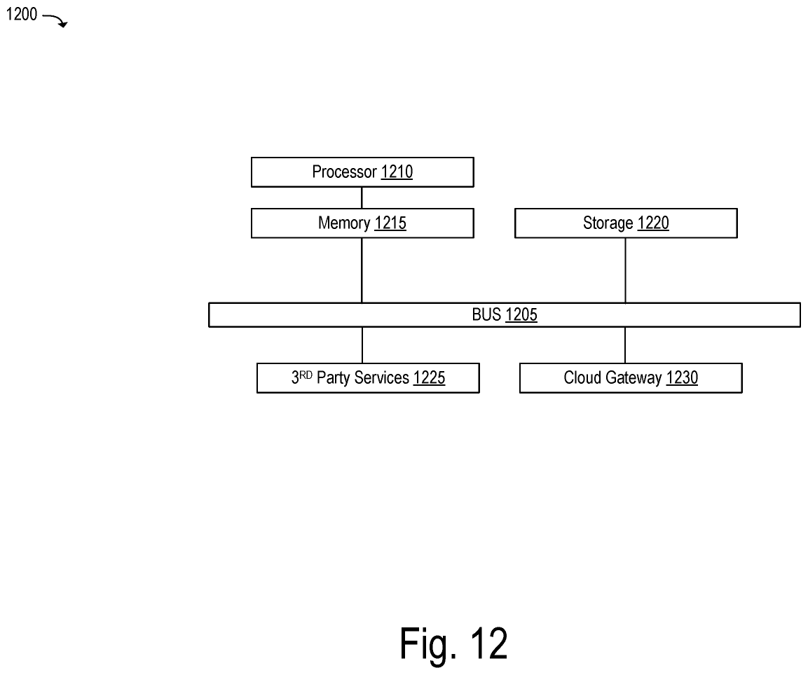

Referring to FIG. 12, FIG. 12 is a schematic illustrating a computing system 1200 that may be used to implement various features of embodiments described in the disclosed subject matter. The terms components, entities, modules, surface, and platform, when used herein, may refer to one of the many embodiments of a computing system 1200. The computing system 1200 may be a single computer, a co-located computing system, a cloud-based computing system, or the like. The computing system 1200 may be used to carry out the functions of one or more of the features, entities, and/or components of a software project.

The exemplary embodiment of the computing system 1200 shown in FIG. 12 includes a bus 1205 that connects the various components of the computing system 1200, one or more processors 1210 connected to a memory 1215, and at least one storage 1220. The processor 1210 is an electronic circuit that executes instructions that are passed to it from the memory 1215. Executed instructions are passed back from the processor 1210 to the memory 1215. The interaction between the processor 1210 and memory 1215 allow the computing system 1200 to perform computations, calculations, and various computing to run software applications.

Examples of the processor 1210 include central processing units (CPUs), graphics processing units (GPUs), field programmable gate arrays (FPGAs), complex programmable logic devices (CPLDs), and application specific integrated circuits (ASICs). The memory 1215 stores instructions that are to be passed to the processor 1210 and receives executed instructions from the processor 1210. The memory 1215 also passes and receives instructions from all other components of the computing system 1200 through the bus 1205. For example, a computer monitor may receive images from the memory 1215 for display. Examples of memory include random access memory (RAM) and read only memory (ROM). RAM has high speed memory retrieval and does not hold data after power is turned off. ROM is typically slower than RAM and does not lose data when power is turned off.

The storage 1220 is intended for long term data storage. Data in the software project such as computer readable specifications, code, designs, and the like may be saved in a storage 1220. The storage 1220 may be stored at any location including in the cloud. Various types of storage include spinning magnetic drives and solid-state storage drives.

The computing system 1200 may connect to other computing systems in the performance of a software project. For instance, the computing system 1200 may send and receive data from 3^{rd} party services such as Office 365 and Adobe. Similarly, users may access the computing system 1200 via a cloud gateway 1230. For instance, a user on a separate computing system may connect to the computing system 1200 to access data, interact with the run entities 108, and even use 3^{rd} party services 1225 via the cloud gateway.

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for configuring a hardware needed for a developer to run an undeveloped device application, the method comprising:
providing a developer with a multitude of features, the features selectable, by the developer, for the undeveloped device application;
receiving a selection of features from the multitude of features;
generating a machine-readable specification, capable of implementing the selection of features, for the undeveloped device application; and
generating a hardware configuration for the developer, the hardware configuration capable of performing the selection of features of the machine-readable specification.

2. The method of claim 1, wherein generating the hardware configuration comprises minimizing a resource cost of the hardware configuration for the developer.

3. The method of claim 2, further comprising applying the hardware configuration to one or more hardware providers; and
determining a resource cost for the hardware configuration on each of the one or more providers.

4. The method of claim 3, further comprising opening an account for the developer with at least one of the one or more providers.

5. The method of claim 1, wherein generating the hardware configuration comprises using a machine learned algorithm that is trained on historical data of core features and corresponding hardware configurations.

6. The method of claim 5, wherein generating the hardware configuration further comprises mapping one or more features of the selection of features to one or more closest core features.

7. The method of claim 1, further comprising receiving, from the developer, a selection of concurrent users for the undeveloped device application; and
wherein generating the hardware configuration is based on the selection of concurrent users.

8. A computer system to predict a hardware capable of running an undeveloped device application, the computer system comprising:
a processor coupled to a memory, the processor configured to:
provide a developer with a multitude of features, the features selectable, by the developer, for the undeveloped device application;
receive a selection of features from the multitude of features;
generate a machine-readable specification, capable of implementing the selection of features, for the undeveloped device application; and
generate a hardware configuration for the developer, the hardware configuration capable of performing the selection of features of the machine-readable specification.

9. The computer system of claim 8, wherein generate the hardware configuration comprises the processor being further configured to minimize a resource cost of the hardware configuration for the developer.

10. The computer system of claim 9, wherein the processor is further configured to:
apply the hardware configuration to one or more hardware providers; and
determine a resource cost for the hardware configuration on each of the one or more providers.

11. The computer system of claim 10, wherein the processor is further configured to open an account for the developer with at least one of the one or more providers.

12. The computer system of claim 8, wherein generate the hardware configuration comprises the processor being configured to use a machine learned algorithm that is trained on historical data of core features and corresponding hardware configurations.

13. The computer system of claim 12, wherein generate the hardware configuration comprises the processor being configured to map one or more features of the selection of features to one or more closest core features.

14. The computer system of claim 8, wherein the processor is further configured to receive, from the developer, a selection of concurrent users for the undeveloped device application; and
wherein generate the hardware configuration is based on the selection of concurrent users.

15. A computer readable storage medium having data stored therein representing software executable by a computer, the software comprising instructions that, when executed, cause the computer readable storage medium to perform:
providing a developer with a multitude of features, the features selectable, by the developer, for an undeveloped device application;
receiving a selection of features from the multitude of features;
generating a machine-readable specification, capable of implementing the selection of features, for the undeveloped device application; and
generating a hardware configuration for the developer, the hardware configuration capable of performing the selection of features of the machine-readable specification.

16. The computer readable storage medium of claim 15, wherein generating the hardware configuration comprises minimizing a resource cost of the hardware configuration for the developer.

17. The computer readable storage medium of claim 16, wherein the instructions further cause the computer readable storage medium to perform:
applying the hardware configuration to one or more hardware providers; and
determining a resource cost for the hardware configuration on each of the one or more providers.

18. The computer readable storage medium of claim 17, wherein the instructions further cause the computer readable storage medium to perform opening an account for the developer with at least one of the one or more providers.

19. The computer readable storage medium of claim 15, wherein generating the hardware configuration comprises using a machine learned algorithm that is trained on historical data of core features and corresponding hardware configurations.

20. The computer readable storage medium of claim 19, wherein generating the hardware configuration further comprises mapping one or more features of the selection of features to one or more closest core features.
